(19) United States
(12) Patent Application Publication
(10) Pub. No.: US 2022/0112085 A1
(43) Pub. Date: Apr. 14, 2022

(54) Hollow carbon sphere with multi-stage pore structure and preparation method therefor

(71) Applicant: Jinhua Chenyang Technology Co., Ltd., Jinghua, Zhejiang (CN)

(72) Inventor: Zhongwei Chen, Jinghua, Zhejiang (CN)

(21) Appl. No.: 17/424,399

(22) PCT Filed: Jan. 21, 2019
(86) PCT No.: PCT/CN2019/072481

§ 371 Date: Jul. 20, 2021

(51) Int. Cl. C01B 32/05

(52) U.S. Cl. CPC C01B 32/05; C01P 2006/16; C01P 2006/14; C01P 2006/12

(57) ABSTRACT

A hollow carbon sphere with a multi-stage pore structure. The hollow carbon sphere may have a multi-stage pore structure, and have micropores, mesopores and macropores, wherein the pore diameter of the micropores is not greater than 2 nm, the pore diameter of the mesopores is distributed between 2-50 nm, and the pore diameter of the macropores is greater than 50 nm; the pore volume contributed by the micropores is 0.047-0.30 cm³/g; the pore volume contributed by the mesoporous is 0.15-0.49 cm³/g; the pore volume contributed by the macropores is 0.07-0.80 cm³/g; and the grain size of the hollow carbon sphere is 2.5-6.5 μm, the wall thickness thereof is 5-8 nm, and the specific surface area thereof is 443.23 m²/g. Further provided is a method for preparing the material. The carbon sphere may have thin walls, a high porousness, a high specific surface area, etc., which can enhance the application performance thereof.

### TECHNICAL FIELD

The present invention relates to the field of porous carbon materials, and in particular, to a hollow carbon sphere having a multi-stage pore structure and a preparation method thereof.

### BACKGROUND

The use of carbon materials can be traced back to human ancient times. Hollow carbon spheres are characterized by high conductivity, good thermal conductivity, good thermal stability, good corrosion resistance, light quality and molecular structure, so that it is used in the fields of batteries, chemicals, mechanical, electronics, aerospace, metallurgy and nuclear energy widely. In recent years, with the discovery and development of carbon materials such as C₆₀, carbon nanotubes and graphene, it has been found that its microstructure, such as the aperture size, has a decisive role in the nature and use of the material. Generally, the pore diameter is less than 2 nanometers as micropores, greater than 50 nm as micropores, and between the two as mesopores. Multi-stage pores refer to simultaneous contained micropores, mesopores and macropores. Carbon materials having multi-stage pores have conventional properties, also have a macropores structure, a short range diffusion path, a high ratio surface area, and a high porosity or the like, which facilitates adsorption and transmission of active materials, thereby having higher application performance. Based on the dimension, the hollow structure can significantly increase its specific area, reduce its density, which is beneficial to further improve its performance.

The method of currently preparing hollow carbon spheres mainly includes high temperature pyrolysis, laser distillation, template method, and arc discharge method. Developing a simple and efficient multi-stage pore structure hollow carbon sphere preparation method is one of the important challenges.

In the prior art, there is no public report on the preparation method of hollow carbon sphere in multi-stage pore structure. Although multi-stage well carbon materials and hollow carbon spheres have been reported, such as the preparation method of multi-stage pore material is disclosed, for example, Chinese patent CN104528720A; CN105731419A discloses a method for preparing a rod-shaped multi-stage well carbon material; CN103537262B discloses a method of preparing a nitrogen doped multi-stage pore carbon material; CN104310368A discloses a method of preparing hollow carbon spheres; CN100537422C discloses a method for preparing hollow micron carbon spheres in size; CN104319402B disclosed method of preparation of multi-layer carbon empty ball negative material. However, these the main differences of the present invention from the prior arts include: (1) the carbon sphere structure is different; the sample prepared by the present invention simultaneously contains two structures of multi-stage pores and hollow pores; 2, the preparation method, the present invention contains spray drying method to prepare carbon sphere particles.

Based on the above, a carbon sphere and a preparation method thereof having a multi-stage pore and hollow structure are expected. The special structure in the carbon sphere has the following characteristics: wall thin, porous and high ratio surface area, which is advantageous for its potential application in the fields of energy storage, chemicals, and mechanical electronics. Further, in the preparation method of the carbon spheres provided by the present invention, the step of spray drying comprises the use of the obtained carbon sphere while multi-stage pore and hollow structures, thereby having excellent properties of wall thin, porous and high ratio surface area.

### SUMMARY OF THE INVENTION

The technical problem to be solved by the present invention is to provide a hollow carbon sphere having a multi-stage pore structure and a preparation method thereof. The hollow carbon sphere is thin, porous and high ratio surface area provided by the present invention, and the preparation method of the present invention is simple and cost-effective, suitable for industrial production, wide range of applications.

The object of the present invention and resolving its technical problems by the following technical solutions. In accordance with the present invention, a hollow carbon sphere having a multi-stage pore structure is a multi-stage pore structure, which has micropores, mesopores and macropores; wherein the microporous pore diameter is not greater than 2 nm, the mesopores pore diameter is 2˜50 nm, the macropores pore diameter is greater than 50 nm; the pore volume contributed by the micropores is 0.047-0.30 cm³/g; the pore volume contributed by the mesoporous is 0.15-0.49 cm³/g; the pore volume contributed by the macropores is 0.07-0.80 cm³/g.

The foregoing hollow carbon sphere, wherein the grain size of the hollow carbon sphere is 2.5-6.5 μm, the wall thickness thereof is 5-8 nm, and the specific surface area thereof is 443.23 m₂/g.

The objectives and solve the technical problems of the present invention are also implemented by using the following technical solutions. A method of preparing hollow carbon spheres having a multi-stage pore structure in accordance with the present invention includes the following steps:

Step (1): Dissolving a carbon source in the solvent to obtain a carbon source precursor solution, the resulting carbon source precursor solution concentration is 5-30 g/L;

Step (2): Adding a metal salt mixed to the resulting carbon source precursor solution obtained by step (1), stirring well to obtain a carbon source solution;

Step (3): The carbon source solution obtained in the above step (2) is spray dried under a certain temperature and air pressure at a certain extrusion pump rate to get a dried product;

Step (4): The dried product obtained in the above step (3) is pre-oxidized under certain conditions to get an oxidized product;

Step (5): Under an argon atmosphere, the oxidized product in the above step (4) is calcined to get a hollow carbon sphere having a multi-stage pore structure.

The aforementioned preparation method, wherein the carbon source in the above step (1) is selected from one or more of an oxidized graphene, glucose, acetic acid, phospholipid, gelatin, fructose or lactose.

The aforementioned preparation method, wherein the solvent in the above step (1) is selected from one or more of ethanol, water, methanol, ethylene glycol or acetone.

The aforementioned preparation method, wherein the metal salt in the above step (2) is selected one or more from the group consisting of sodium nitrate, sodium carbonate, sodium sulfate, potassium chloride, potassium nitrate or sodium nitrate or sodium chloride.

The aforementioned preparation method, wherein the metal salt described in the step (2) is added in an amount (1-20): 1 of the weight ratio of the metal salt and the carbon source.

The aforementioned preparation method, wherein the spray dryed conditions in the step (3) are: the temperature is 150-300° C., the air pressure is 0.07-0.23 bar, and the extrusion pump rate is 5-35 R/min.

The aforementioned preparation method, wherein the pre-oxidation conditions in step (4) are: the temperature is 100-290° C., the time 1-17 hours.

The aforementioned preparation method, wherein the calcination temperature in the step (5) is from 500 to 1300° C., and the time is 3-8 hours.

By the above technical solution, the present invention (name) has at least the following advantages:

(1) The proposed hollow carbon sphere having a multi-stage pore structure has a particle diameter of 2.5 to 6.5 μm, a wall thin, and a thickness of only 5-8 nm, a specific surface area, which can reach 443.23 m²/g.

(2) Hollow carbon spheres proposed the present invention have a multi-stage pore structure and a hollow structure in which micropores, mesopores and macropores are simultaneously having a multi-stage pore structure. Carbon material is conventional nature, also has a macropores structure, a short-range diffusion path, a high ratio surface area, and a high porosity or the like, which facilitates adsorption and transmission of active materials, thereby having higher application performance, based on the dimensional size. The hollow structure can significantly increase its specific area, reduce its density, which is conducive to further improve its performance.

(3) The present invention also provides a method of preparing a hollow carbon sphere having a multi-stage pore structure, including a spray drying step to prepare multi-stage pore structure carbon microsphere particles, wherein the spray drying step can facilitate uniform distribution of particle size; re-prepared carbon sphere particles of the hollow structure by thermal cracking. The entire preparation method is simple, low cost, suitable for industrial production, wide range of applications.

In summary, hollow carbon spheres of a multi-stage pore structure provided by the present invention provide a uniform size distribution, a porous carbon sphere having high specific surface area, which is more suitable for practicality and has an industrial value.

The material has the above advantages and practical value, and there is no similar design public published or used in similar products, which is innovative, regardless of the preparation method or in function, in technology.

The above description is merely an overview of the technical solution of the present invention, in order to understand the technical means of the present invention, and may be implemented in accordance with the present invention, the preferred example of the present invention will be described in detail.

The specific preparation method of the present invention and the structure thereof are given in detail by the following examples.

### DESCRIPTION OF THE DRAWIINGS

FIG. 1 is a SEM electron microbial map of hollow carbon spheres having a multi-stage pore structure in accordance with Example 1 of the present invention;

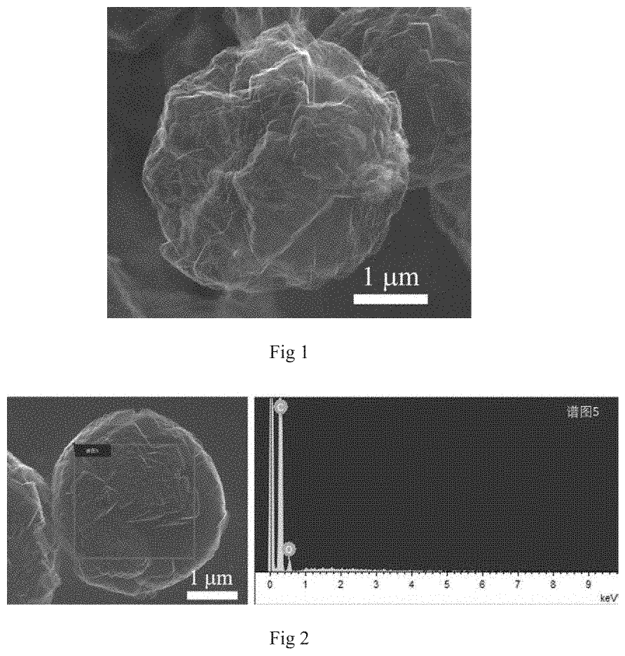

FIG. 2 is a map of hollow carbon sphere EDX elements having multi-stage pore structures prepared in Example 1 in accordance with the present invention;

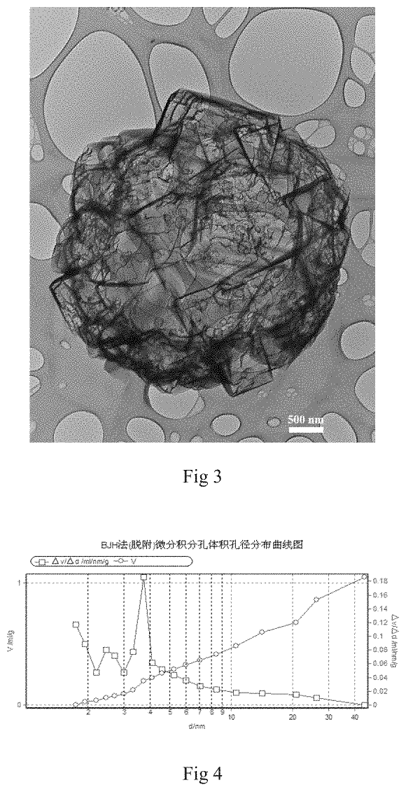

FIG. 3 is a TEM electron showing a hollow carbon sphere having a multi-stage pore structure in accordance with Example 1 of the present invention;

FIG. 4 is a specific surface area BET test diagram of hollow carbon spheres having multi-stage pore structures prepared in Example 1 of the present invention;

FIG. 5 is a hollow carbon sphere SEM electron microscope table having a multi-stage pore structure in accordance with Example 2 of the present invention;

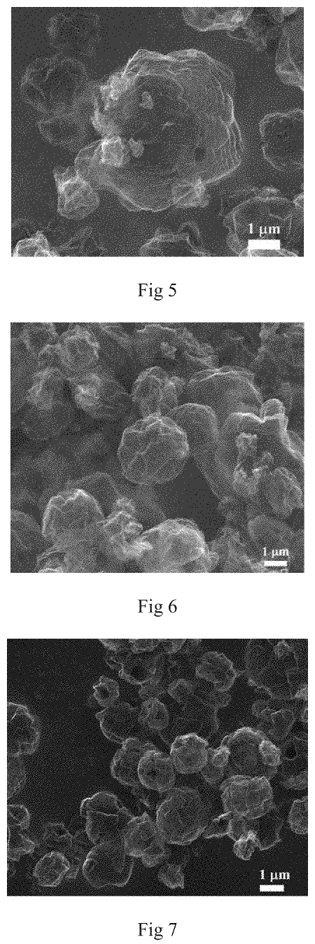

FIG. 6 is a hollow carbon sphere SEM electron microscope table with multi-stage pore structure prepared in accordance with Example 3 of the present invention;

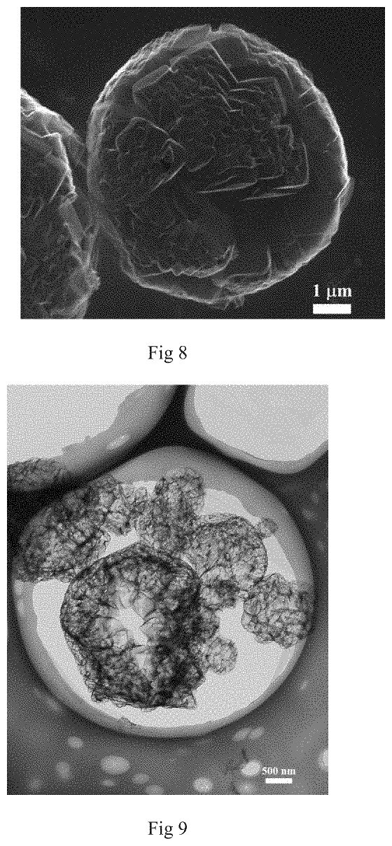

FIG. 7 is a hollow carbon sphere SEM electron microscope table with multi-stage pore structure prepared in Example 4 of the present invention;

FIG. 8 is a hollow carbon sphere SEM electron microscope table having a multi-stage pore structure in accordance with Example 5 in accordance with the present invention;

FIG. 9 is a hollow carbon sphere TEM electron microscope table with multi-stage pore structure prepared in accordance with Example 6 of the present invention;

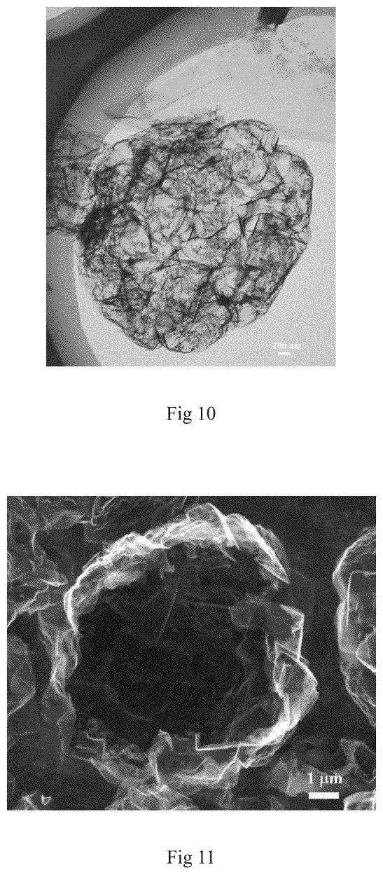

FIG. 10 is a hollow carbon sphere TEM electron microscope table having a multi-stage pore structure in accordance with Example 7 of the present invention;

FIG. 11 is a hollow carbon sphere SEM electron microscope table having a multi-stage pore structure in accordance with Example 8 of the present invention;

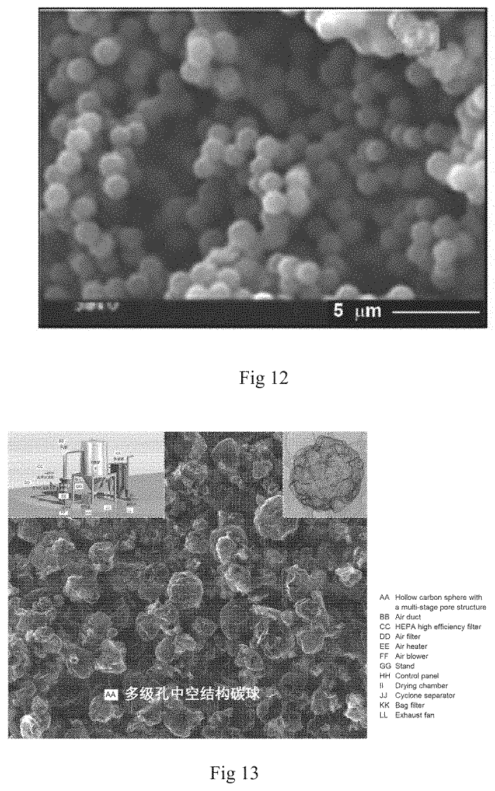

FIG. 12 is a sample of a carbon sphere SEM electron microscope table prepared in the first example of the present invention; and

FIG. 13 is a hollow carbon sphere having a multi-stage pore structure of the present invention.

### DETAILED DESCRIPTION OF THE INVENTION

The present invention is intended to illustrate the scope of the invention and the appended claims. It will be appreciated that those skilled in the art will also do various modifications or modifications to the present invention after reading the present invention, and these equivalents also fall in the scope of the appended claims.

### EXAMPLE 1

0.5 g of the oxidized graphene is dissolved in 100 ml of ethanol, and a carbon source precursor solution having a concentration of 5 g/L was prepared. 0.55 g of sodium nitrate mixed was added to the above-mentioned carbon source precursor solution and stirred well to get a carbon source solution. The said carbon source solution was spray dried under the temperature of 150° C. and the air pressure was 0.07 bar and the extrusion pump speed of 5 R/min was subjected to a dry product. Then pre-oxidation was done at 100° C. for 10 hours. Finally, in an argon atmosphere, a hollow carbon sphere having a multi-stage pore structure was obtained at 700° C. for 3 hours.

FIG. 1 is a SEM electron microscopy of hollow carbon spheres having multi-stage pore structures in accordance with Example 1 of the present invention. It can be seen that the prepared particle morphology is spherical, and its size is about 3.5 microns.

FIG. 2 is a centralized carbon sphere EDX element profile having a multi-stage pore structure prepared in Example 1 in Example 1. It can be seen that the carbon element content reaches 95%, only a small amount of oxygen impurities.

FIG. 3 is a TEM electron microbial map of hollow carbon spheres having multi-stage pore structures in accordance with Example 1 of the present invention. As can be seen from the figure, the topography of the carbon sphere is spherical, and the structure is a hollow structure, the spherical wall is thin, and the thickness is about 5 nm.

FIG. 4 is a specific surface area Bet test diagram of hollow carbon spheres having multi-stage pore structures in accordance with Example 1 of the present invention. It can be seen from which the spherical material contains less than 2 nm micropores, mesopores between 2 nanometers and 50 nm, and micropores greater than 50 nanometers, that is, a multi-stage pore structure. According to the BET test results, the pores contributed by the micropores is 0.047 to 0.30 cm³/g, the pore volume contributed by the mesopores is from 0.07 to 0.80 cm³/g. Its specific surface area is higher than that of 443.23 m²/g.

### Example 2

The same operation as in Example 1, just adjusting the concentration of the carbon source, as follows:

3 g of oxidized graphene is dissolved in 100 mL of ethanol, and a carbon source precursor solution having a concentration of 30 g/L was obtained. The above-mentioned carbon source precursor solution was added to 11.4 g of sodium nitrate and mixed with stirring, and the carbon source solution was obtained. The above carbon source solution was spray dried under the temperature of 150° C. and the air pressure was 0.07 bar and the extrusion pump speed was 5 R/min, to get a dry product. Then oxidation was done at 100° C. for 10 hours. Finally, in an argon atmosphere, a hollow carbon sphere having a multi-stage pore structure was obtained at 700° C. for 3 hours.

FIG. 5 is a hollow carbon sphere SEM electron microscope table having a multi-stage pore structure in accordance with Example 2 of the present invention. It can be seen from the figure that the prepared carbon sphere particles are spherical, with a size of 5 microns, and the particle size distribution is not very uniform.

### Example 3

The same operation as in Example 1, and only adjusting the type of carbon source, as follows:

0.5 g of glucose was dissolved in 100 ml of ethanol, and a carbon source precursor solution having a concentration of 5 g/L was obtained. 0.55 g of sodium nitrate mixed was added to the above-mentioned carbon source precursor solution and stirred, resulting in a carbon source solution. The above carbon source solution was spray dried under the temperature of 150° C. and the air pressure was 0.07 bar and the extrusion pump speed of 5 R/min was subjected to a dry product. Then oxidation was done at 100° C. for 10 hours. Finally, in an argon atmosphere, a hollow carbon sphere having a multi-stage pore structure was obtained at 700° C. for 3 hours.

FIG. 6 is a hollow carbon sphere SEM electron microscope table with multi-stage pore structures prepared in accordance with Example 3 of the present invention. It can be seen that the prepared carbon sphere particles are spherical, and the size is about 3 microns.

### Example 4

The same operation as in Example 1, only adjusting the type of solvent, as follows:

0.5 g of the oxidized graphene is dissolved in 100 ml of water, and to the concentration of 5 g/L is prepared to obtain a carbon source precursor solution. 0.55 g of sodium nitrate was added to the above-mentioned carbon source precursor solution and stirred, resulting in a carbon source solution. The above carbon source solution was spray dried under the temperature of 150° C. and the air pressure was 0.07 bar and the extrusion pump speed of 5 R/min was subjected to a dry product. Then oxidation was done at 100° C. for 10 hours. Finally, in an argon atmosphere, a hollow carbon sphere having a multi-stage pore structure was obtained at 700° C. for 3 hours.

FIG. 7 is a hollow carbon sphere SEM electron microscope table having a multi-stage pore structure prepared in accordance with Example 4 of the present invention. It can be seen from the figure that the prepared carbon sphere particles are spherical, with a size of about 2.5 microns, and the particle size is more uniform.

### Example 5

The same operation as in Example 1, only adjusting the mass ratio of the carbon source and the salt, as follows:

0.5 g of the oxidized graphene is dissolved in 100 ml of water, and the concentration of 5 g/L is prepared to obtain a carbon source precursor solution. 11 g of sodium nitrate was mixed and added to the carbon source precursor solution to give a carbon source solution. The above carbon source solution was spray dried under the temperature of 150° C. and the air pressure was 0.07 bar and the extrusion pump speed of 5 R/min was subjected to a dry product. Then oxidation was done at 100° C. for 10 hours. Finally, in an argon atmosphere, a hollow carbon sphere having a multi-stage pore structure was obtained at 700° C. for 3 hours.

FIG. 8 is a hollow carbon sphere SEM electron microscope table having a multi-stage pore structure in accordance with Example 5 of the present invention. It can be seen that the prepared carbon sphere particle morphology is spherical, and its size is about 6 microns.

### Example 6

The same operation as in Example 1, but the relevant reaction conditions are adjusted, as follows:

0.5 oxidized graphene is dissolved in 100 mL of ethanol, and a carbon source precursor solution having a concentration of 5 g/L was obtained. 0.55 g of sodium nitrate mixed with sodium nitrate was added to the above-mentioned carbon source precursor solution and stirred and uniform, resulting in a carbon source solution. The above carbon source solution was spray dried under the temperature of 300° C. and the air pressure was 0.07 bar and the extrusion pump speed of 20 R/min was sprayed, and the product was dried. Then oxidation was done at 290° C. for 1 hour. Finally, in an argon atmosphere, a hollow carbon sphere having a multi-stage pore structure was obtained at 900° C. for 8 hours.

FIG. 9 is a hollow carbon sphere TEM electron microscope table with multi-stage pore structure prepared in accordance with Example 6 of the present invention. As can be seen from the figure, the prepared carbon sphere particle morphology is spherical, and the structure is a hollow structure.

### Example 7

The same operation as in Example 1, but the relevant reaction conditions are adjusted, as follows:

0.5 g of the oxidized graphene is dissolved in 100 ml of ethanol, and a carbon source precursor solution having a concentration of 5 g/L was prepared. 0.55 g of sodium nitrate was mixed with and added to the above-mentioned carbon source precursor solution and stirred, resulting in a carbon source solution. The above carbon source solution was spray dried under the temperature of 225° C. and the air pressure was 0.23 bar and was sprayed at 35 R/min to give a dry product. Then oxidation was done at 195° C. for 9 hours. Finally, in an argon atmosphere, a hollow carbon sphere having a multi-stage pore structure was obtained at 1300° C. for 3 hours.

FIG. 10 is a hollow carbon sphere TEM electron microscope table having a multi-stage pore structure in accordance with Example 7 of the present invention. It can be seen that the prepared carbon sphere particle morphology is spherical and the structure is a hollow structure, and the wall thickness is about 8 nm.

### Example 8

The same operation as in Example 1, but the relevant reaction conditions are adjusted, as follows:

0.5 g of the oxidized graphene is dissolved in 100 ml of ethanol, and a carbon source precursor solution having a concentration of 5 g/l, was prepared. 0.55 g of sodium nitrate was mixed with and added to the above-mentioned carbon source precursor solution and stirred, resulting in a carbon source solution. The above carbon source solution was spray dried under a temperature of 150° C., a gas pressure of 0.15 bar, and an extorsion pump speed of 5 R/min was subjected to a dry product. Then oxidation was done at 100° C. for 17 hours. Finally, in an argon atmosphere, a hollow carbon sphere having a multi-stage pore structure was obtained at 1300° C. for 6 hours.

FIG. 11 is a hollow carbon sphere SEM electron microscope table having a multi-stage pore structure in accordance with Example 8 of the present invention. It can be seen from the figure that the prepared carbon sphere particle morphology is spherical, and is exposed due to a high temperature of the temperature of the carbon sphere, and the size is about 6.5 microns.

### Control Example 1

Reference (Wei Jing et al, functional materials, 1001-9731 (2014) rations (II)-136-04) discloses a carbon microsphere prepared by hydrothermation methods. Weighing 1.5 g glucose and 60 ml of deionized water was added to the beaker, dissolved; being transferred to 100 mL of the reaction kettle, placed in an oven, 24 hours at 200° C., close the oven, naturally cooled; being poured out of the product in the reaction kettle, centrifuged, and ultrasound, dried to carbon sphere products at 60° C.

FIG. 12 is a graph showing a carbon sphere SEM table prepared in control example 1 of the present invention. As can be seen from the figure, the carbon sphere is a solid bulb, which is uniformly distributed, and the particle size is about 1.8 microns. Thus, according to the carbon sphere structure, the prior art method could not get the hollow multi-stage pore structure in the present invention.

In summary, the preparation method of the present invention includes a spray drying step to prepare a multi-stage pored carbon microsphere particles, wherein the spray drying step can facilitate uniform distribution of particle size; and then preparing the hollow structure by thermal cracking. The entire preparation method for carbon sphere particles is simple, low cost, suitable for industrial production, wide range of applications. The carbon sphere obtained by the preparation method of the present invention has a particle diameter of 2.5 to 6.5 μm, and a thickness of thin wall is only 5-8 nm. According to the BET test results, the pores contributed by the micropores is 0.047 to 0.30 cm³/g, the pore volume contributed by the mesoporous is 0.15-0.49 cm³/g; the pore volume contributed by the macropores is 0.07-0.80 cm³/g; and the specific surface area thereof is high up to 443.23 m²/g. Carbon spheres simultaneously with multi-stage pore structures and hollow structures, wherein the multi-stage pore structure is simultaneously having micropores, mesopores, and macropores, carbon material having multi-stage pores, in addition to routine properties, and has a macropores structure, short range diffusion path, high ratio surface area, and high porosity, etc., it is conducive to the adsorption and transmission of active substances, thereby having higher application performance, on the basis of the dimension, the hollow structure can significantly increase its specific area, reduce its density.

As described above, only the preferred examples of the present invention are intended, but the scope of the invention is not limited thereto, and any technician those skilled in the art, can easily think of change within the technical scope of the present disclosure or Alternative, it should be covered within the scope of the present invention. Therefore, the scope of the invention should be based on the scope of protection of the claims.

1. A hollow carbon sphere having a multi-stage pore structure, the hollow carbon sphere as a multi-stage pore structure, which has micropore, micropores, mesopores and macropores; wherein the microporous pore diameter is not greater than 2 nm, the mesopores diameter is 2-50 nm, the macropores diameter is greater than 50 nm; the pore volume contributed by the micropores is 0.047-0.30 cm³/g; the pore volume contributed by the mesoporous is 0.15-0.49 cm³/g; the pore volume contributed by the macropores is 0.07-0.80 cm³/g.

2. The hollow carbon sphere according to claim 1, wherein the grain size of the hollow carbon sphere is 2.5-6.5 μm, the wall thickness thereof is 5-8 nm, and the specific surface area thereof is 443.23 m²/g.

3. A method of preparation of hollow carbon spheres having a multi-stage pore structure according to claim 1, the method comprising the steps of:
Step (1): Dissolving a carbon source in the solvent to obtain a carbon source precursor solution, the resulting carbon source precursor solution concentration is 5-30 g/L;
Step (2): Adding a metal salt mixed to the resulting carbon source precursor solution obtained by step (1), stirring well to obtain a carbon source solution;
Step (3): The carbon source solution obtained in step (2) is spray dried under a certain temperature and air pressure at a certain extrusion pump rate to get a dried product;
Step (4): The dried product obtained in step (3) is pre-oxidized under certain conditions to get an oxidized product;
Step (5): Under an argon atmosphere, the oxidized product in step (4) is calcined to get a hollow carbon sphere having a multi-stage pore structure.

4. The preparation method of claim 3, wherein the carbon source in step (1) is selected from one or more of an oxidized graphene, glucose, acetic acid, phospholipid, gelatin, fructose or lactose.

5. The preparation method of claim 3, wherein the solvent in step (1) is selected from one or more of ethanol, water, methanol, ethylene glycol or acetone.

6. The preparation method of claim 3, wherein the metal salt in step (2) is selected from one or more of the group consisting of sodium nitrate, sodium carbonate, sodium sulfate, potassium chloride, potassium nitrate or sodium nitrate or sodium chloride.

7. The preparation method according to claim 3, wherein the metal salt described in step (2) is added in an amount (1-20):1 of the weight ratio of the metal salt and the carbon source.

8. The preparation method of claim 3, wherein the spray dried conditions in step (3) are: the temperature is 150-300° C., the air pressure is 0.07-0.23 bar, and the extrusion pump rate is 5-35 R/min.

9. The preparation method of claim 3, wherein the pre-oxidation conditions in step (4) are: the temperature is 100-290° C., the time 1-17 hours.

10. The preparation method of claim 3, wherein the calcination temperature in step (5) is from 500 to 1300° C., and the time is 3-8 hours.
